(19) United States
(12) Patent Application Publication
(10) Pub. No.: US 2009/0185853 A1
(43) Pub. Date: Jul. 23, 2009

(54) RELEASABLE LOCKING MECHANISM

(76) Inventors: Fred Koelling, Foster City, CA (US); Venugopal Subramanyam, Fremont, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/168,809

(22) Filed: Jul. 7, 2008

Related U.S. Application Data
(63) Continuation-in-part of application No. 11/955,295, filed on Dec. 12, 2007.
Application No. 11/955,295 is a continuation-in-part of application No. 11/655,651, filed on Jan. 19, 2007, now Pat. No. 7,534,153.
(60) Provisional application No. 60/760,855, filed on Jan. 20, 2006.

(51) Int. Cl. F16D 1/06

(52) U.S. Cl. 403/229; 403/220

(57) ABSTRACT

The present invention provides attachment devices and methods based upon the concept of vertical, instead of horizontal, locking forces for attachment of a device to an object. In some embodiments, spring force is employed as the actual locking mechanism, and insertion and desertion forces are designed into the spring. The spring may be designed so that the insertion force is less than the desertion force.

### CROSS-REFERENCE TO RELATED APPLICATIONS

This application is a continuation-in-part of U.S. patent application Ser. No. 11/955,295, filed Dec. 12, 2007, entitled “RELEASABLE SPRING-LOCKING MECHANISM FOR RAPID WATERCRAFT FIN ATTACHMENT,” which is a continuation-in-part of U.S. patent application Ser. No. 11/655,651, filed Jan. 19, 2007, entitled “SURFBOARD MANUFACTURING APPARATUS,” which claims the benefit of U.S. Provisional Patent Application No. 60/760,855, filed Jan. 20, 2006, each of which is herein incorporated by reference in its entirety.

### BACKGROUND

1. Field of the Invention

Provided herein are mechanisms whereby a locking force is used to secure a device to another object.

2. Description of the Related Art

Users of watercraft boards generally only have two methods of securing fins to their board. In particular, the user has to use either a set of screws or a snap mechanism, to attach the fins. The screw method may be quite time consuming for the watercraft user to practice. Additionally, screw and snap mechanisms may necessitate the use of multiple moving parts, any of which are subject to rusting, failure, and stress fatigue.

Typically, toe and heel locking mechanisms, as described in the art, have a fin with a front end that has a detent or other feature that toes into the front end of the fin box to lock it into position. At the rear of the fin is a latch, whereby a linear spring may be used to latch the rear of fin into the fin box. A coil at one end of the spring moves into a cavity location within the fin box. The tension in the spring holds the spring coil in the fin box rear detent in order for the fin to stay engaged and in position.

Toe and heel locking mechanisms are prone to failure, as the locking forces are horizontal to the bottom plane of the watercraft. Other toe and heel variations have locking mechanism without springs. Typically, a toe is locked into position using a T-slot, or other configuration. The fin typically has a forward pin, or other attachment piece, that is usually positioned at 90 degrees from the fin box. The pin moves downward into the capture slot and the fin is then pushed forward so that the toe of the fin is locked into position. Another detent at the rear of the fin, or another T-pin or like capture piece, moves downward into the fin box slot and is locked down by a vertically moving lever or a cylindrically positioned cam lever.

Typically, in the variations mentioned above, an end-user has to provide a counter force along the horizontal plane to disengage the locking mechanisms. The reason this is undesirable is that in many watercraft situations a user might encounter such horizontal forces from the environment, for example, the watercraft fins could be exposed to such horizontal forces from contact with kelp, rocks, ropes, wood, sand, other watercraft, etc., and such contact could trigger the unwanted partial or full release of a fin. Therefore, prior art fin attachment systems may be prone to both mechanical and common use failures, and also may be too complicated to allow an user to quickly and effectively change his or her fin choices to adapt to a given situation.

Conventional traction gear for footwear use a large number of individual traction elements, such as cleats, that are attached to the outsole of a shoe. Generally, individual cleats must be screwed into the sole of a shoe, involving much time. Further, the use of screw mechanisms to secure cleats to the soles of a shoe is not ideal inasmuch as the screws may loosen. Finally, conventional designs typically employ the use of metal attachment elements, which add considerable weight to the footwear.

### SUMMARY

Embodiments disclosed herein relate to attachment devices that can be used to attached a device to an object. In a first aspect, the embodiments disclosed herein relate to an attachment mechanism to secure a device to an object. The attachment mechanism disclosed herein includes a device receptacle configured to fit within a cavity of the object to which the device is attached. The device receptacle can include a housing with an interior cavity. The interior cavity can be configured to receive the device. The device attachment mechanism also includes a device that has a top portion and a bottom portion, the bottom portion including a post with an annular groove. In some embodiments, the device can include a locking means to retain the annular groove of the post in a fixed position within the device receptacle, wherein the locking means is either located on the post or within the interior cavity of the device receptacle, prior to insertion of the post into the device receptacle. In some embodiments, the locking means can be a spring, such as a split ring spring, a coiled cantilevered spring, a split pin post, or the like.

In one embodiment of the first aspect, the device receptacle can include a split ring spring with a hole having a diameter, wherein the wherein the diameter of the hole of the split ring spring is the same as the diameter of the annular groove of the post, and wherein the diameter of the hole of the split ring spring can expand to the size of the diameter of the outside edge of the post.

In some embodiments of the first aspect, the device receptacle can also include a housing lid with an aperture, wherein the diameter of the aperture is the same as the diameter of the outside edge of the post. In some embodiments, the split ring spring and the housing lid sit within the interior cavity of the housing, and the housing lid and the housing base are attached, for example, releasably attached or integrally attached.

In some embodiments, the edges defining the annular groove of the post are angled. In some embodiments, the edges defining the hole of the split ring are angled as well, such that the edges defining the annular groove of the post and the angles of the edges defining the hole of the split ring are complementary. In some embodiments, the angle of the edges forming the annular groove determines the strength of the locking means.

In some embodiments of the first aspect, the post can be a split post, wherein the split post comprises mouths configured to enable compression of the split post to be received into the interior cavity of the housing receptacle.

In some embodiments of the first aspect, the device can be a cleat and the object can be a shoe. In other embodiments, the device can be a fin and the object can be a watercraft. In some embodiments, the device can be a skateboard deck and the object can be a skateboard wheel truck. In some embodiments, the device and object can be elements of furniture.

In a second aspect, the embodiments disclosed herein relate to a shoe, comprising a sole. The sole can include a first portion attached to the bottom of the shoe, the first portion of the sole having at least one cavity configured to receive a device receptacle. The shoe also includes a device receptacle comprising a housing, a split ring spring and a housing lid, wherein the split ring spring and the housing lid sit within an interior cavity of the housing. The shoe can also include a cleat that has a top portion and a bottom portion, wherein the top portion includes a post. The post can have an annular groove, wherein the annular groove of the post has diameter that is smaller than the diameter of the outside edge of the post.

In some embodiments of the second aspect, the device receptacle can include a split ring spring with a hole having a diameter, wherein the diameter of the hole of the split ring spring is the same as the diameter of the annular groove of the post, and wherein the diameter of the hole of the split ring spring can expand to the size of the diameter of the outside edge of the post.

In some embodiments of the second aspect, the device receptacle further includes a housing lid with an aperture, wherein the diameter of the aperture is the same as the diameter of the outside edge of the post.

In some embodiments of the second aspect, the split ring spring and the housing lid sit within the interior cavity of the housing.

In some embodiments of the second aspect, the edges defining the annular groove of the post are angled. In some embodiments, the edges defining the hole of the split ring are also angled, such that the angles of the edges defining the annular groove of the post and the angles of the edges defining the hole of the split ring are complementary.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

These and other features and advantages of the various embodiments disclosed herein will be better understood with respect to the following description and drawings, in which like numbers refer to like parts throughout, and in which:

FIG. 1 is a diagram illustrating a top perspective view of a first version of a fin box in accordance with one embodiment of the invention.

FIG. 2 is a diagram illustrating a bottom perspective view of the first version of the fin box of FIG. 1.

FIG. 3 is a diagram illustrating a top perspective view of a second version of a fin box in accordance with one embodiment of the invention.

FIG. 4 is a diagram illustrating a bottom perspective view of the second version of the fin box of FIG. 3.

FIG. 5 is a diagram illustrating a cross sectional view of a wedge shaped lip or barb being inserted into a fin cavity of a surfboard watercraft in accordance with one embodiment of the invention.

FIG. 6 is a diagram illustrating a top perspective view of a third version of a fin box in accordance with one embodiment of the invention.

FIG. 7 is a diagram illustrating a bottom perspective view of the third version of the fin box of FIG. 6.

FIG. 8 is a diagram illustrating a top perspective view of a fourth version of a fin box in accordance with one embodiment of the invention.

FIG. 9 is a diagram illustrating a bottom perspective view of the fourth version of the fin box of FIG. 8.

FIG. 10 is a diagram illustrating a side view of a fin being attached to a fin box, and more particularly, posts of the fin being inserted into the fin apertures of the fin box in accordance with one embodiment of the invention.

FIG. 11 is a diagram illustrating a cross sectional view of the post and fin aperture of FIG. 10 illustrating a first version of the attachment between the post and fin aperture.

FIG. 12 is a diagram illustrating a second version of the attachment between the post and fin aperture in accordance with one embodiment of the invention.

FIG. 13 is a diagram illustrating an example canted spring design in accordance with the invention.

FIG. 14 is a diagram illustrating an example fin plug design in accordance with the invention.

FIG. 15 is a diagram illustrating another example fin plug design in accordance with the invention.

FIG. 16 is a diagram illustrating a canted spring latch that depicts possible surf pin locations on a fin in accordance with the invention.

FIG. 17 is a diagram illustrating a side view of a fin having a split ring assembly of an embodiment of a locking mechanism disclosed herein.

FIG. 18 is a diagram illustrating a side view of a fin having a split post assembly of an embodiment of a locking mechanism disclosed herein.

FIG. 19 is a diagram illustrating a detailed view of a split post assembly of an embodiment of a locking mechanism disclosed herein.

FIG. 20 is a diagram illustrating a skateboard assembly of an embodiment of a locking mechanism disclosed herein.

FIG. 21 is a diagram illustrating a furniture assembly of an embodiment of a locking mechanism disclosed herein.

FIG. 22 is an exploded cross-sectional view of an embodiment of a locking mechanism disclosed herein.

FIG. 23 is a cross-sectional view of an embodiment of a locking mechanism disclosed herein.

FIGS. 24A and 24B show a top view and a cross sectional view, respectively of an exemplary base housing for an embodiment of the locking mechanism disclosed herein.

FIGS. 24C and 24D show a top view and a cross sectional view, respectively, of an exemplary base housing lid for an embodiment of the locking mechanism disclosed herein.

FIGS. 24D and 24F show a top view and a cross sectional view, respectively, of an exemplary split ring for an embodiment of the locking mechanism disclosed herein.

FIG. 24G depicts a cross sectional view of exemplary device (cleat) to be used with the locking device disclosed herein.

FIG. 25 depicts an exploded perspective view of a single cleat according to one embodiment of the locking mechanism disclosed herein.

FIG. 26 depicts an exploded perspective view of a shoe sole and a plurality of cleats according to one embodiment of the locking mechanism disclosed herein.

### DETAILED DESCRIPTION

Embodiments disclosed herein relate to attachment methods and devices that utilize vertical locking forces to releasably, and securely attach a device to an object. The attachment methods and devices disclosed herein are applicable to a wide range of objects and devices. As discussed below, the attachment methods and devices disclosed herein can be advantageously used to couple a device to an object, wherein the device extends vertically from the object when attached, and is likely to encounter horizontal forces when attached to the object. For example, the attachment mechanisms disclosed herein can be used to attach a fin to a surfboard or other watercraft, a cleat to a shoe, a wheel truck to a rollerskate, rollerblade, or skateboard deck, a blade to an ice skate, components of components of furniture, or various other device/object pairs.

As discussed below, some embodiments disclosed herein relate to attachment devices and methods that utilize spring locking means, e.g., canted coiled springs, cantilevered springs, split ring springs, split pin springs, or the like.

Before describing the invention in detail, it is useful to describe an example environment with which the invention can be implemented. One such example is that of a surfboard. A surfboard is a type of watercraft that is generally longer than it is wide. The board generally forms a buoyant deck that a surfer may stand on while surfing. It will be understood, however, that surfboards may also for used for paddling, e.g., while sitting, laying, etc. Additionally, other methods of propulsion may be attached to the surfboard, such as a sail, e.g., for windsurfing. Many modern surfboards may be made of polystyrene or polyurethane foam. The boards may be covered with one or more layers of fiberglass cloth and a resin such as polyester or epoxy resin.

As mentioned above, various embodiments of the attachment devices and methods disclosed herein may be used in conjunction with surfboards and other watercraft. In some embodiments, the fin attachment devices and methods disclosed herein are based upon the concept of spring locking. In some embodiments, the spring locking may be part of the surfboard. For example, in one embodiment, a canted spring can be part of a housing built into a surfboard. In some embodiments, the housing can receive a shaft that may be held in place by the canted spring. In another embodiment, the canted spring can be part of the fin assembly. In various embodiments, the systems and methods described herein are based on the concept of vertical, rather than of horizontal, locking forces for attachment of a device to an object, e.g., a fin device to watercraft object, a cleat, wheel truck, or blade device to the sole of a shoe, a toe plate device comprising a plurality of cleats to the sole of a shoe, a wheel truck device to a skateboard, components of furniture, or the like.

From time-to-time, the present invention is described herein in terms of exemplary environments, e.g., water. Description in terms of these environments is provided to allow the various features and embodiments of the invention to be portrayed in the context of an exemplary application. After reading this description, it will become apparent to one of ordinary skill in the art how the invention can be implemented in different and alternative environments.

Although the figures provided herein are for the purposes of illustrating a fin locking system for watercraft, a cleat locking system for a shoe, a wheel-truck locking mechanism for a skateboard deck, and a locking mechanism for components of furniture, the particular embodiments disclosed herein and illustrated in the figures are for the purpose of illustration only, and should not be construed as limiting the scope of the embodiments disclosed herein.

### Fin Attachment Means

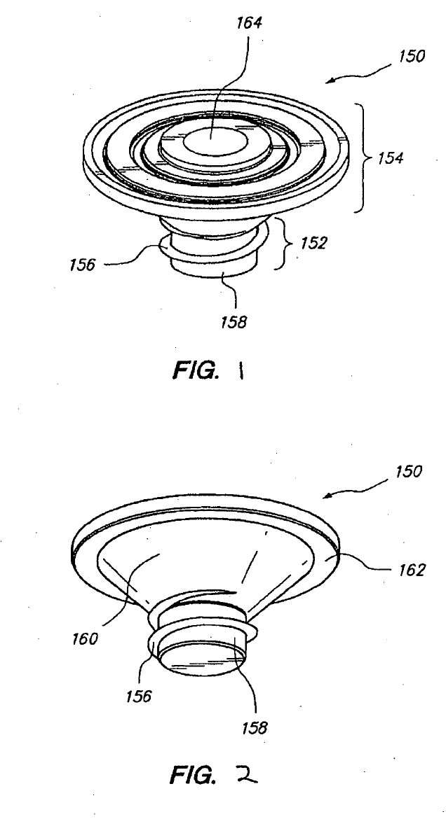

FIGS. 1-19 illustrate various embodiments wherein the attachment mechanism disclosed herein is used for attaching a fin device to a watercraft object, e.g. a surfboard. FIGS. 1-9 illustrate four configurations of fin boxes 150, 170, 200, and 220, which are discussed further below. In some embodiments, during a machining or routing step, a corresponding fin cavity may be formed within the watercraft and exposed through an exterior skin (e.g., first side) of the watercraft to receive the fin boxes 150, 170, 200, 220. Some embodiments may also include a leash plug. In some embodiments, protective caps may be inserted into the fin apertures to prevent coating material and paint from entering the fin apertures.

As discussed above, FIGS. 1-9 illustrate four different versions of the fin box 150, 170, 200, and 220. FIG. 1 is a diagram illustrating a top perspective view of a first version of a fin box in accordance with one embodiment of the invention. FIG. 2 is a diagram illustrating a bottom perspective view of the first version of the fin box of FIG. 1. Referring now to FIGS. 1 and 2, a first version of the fin box 150 may have a round configuration. The fin box 150 has a lower portion 152 and an upper portion 154 that is coaxially aligned with the lower portion 152. The lower portion 152 may have a coarse pitched thread 156 formed on a cylindrical exterior surface 158 of the lower portion 152. The upper portion 154 may have a frusto-conical surface 160 with a radially extending flange 162. A matching fin cavity may be fit into the frusto-conical surface 160, flange 162 and the cylindrical exterior surface 158. To attach the fin box 150 to the watercraft, the thread 156 of the fin box 150 may be screwed into the fin cavity. In one embodiment, two fin cavities may be formed in the watercraft such that fin apertures 164 of the fin boxes 150 are approximately 1.5 inches apart from each other to receive corresponding posts of a fin.

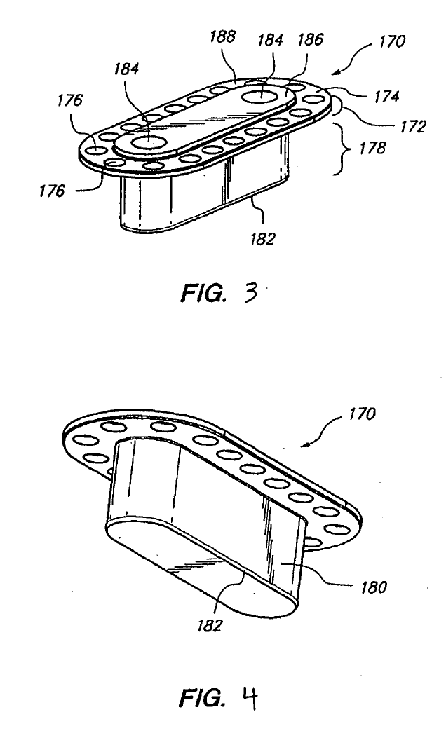

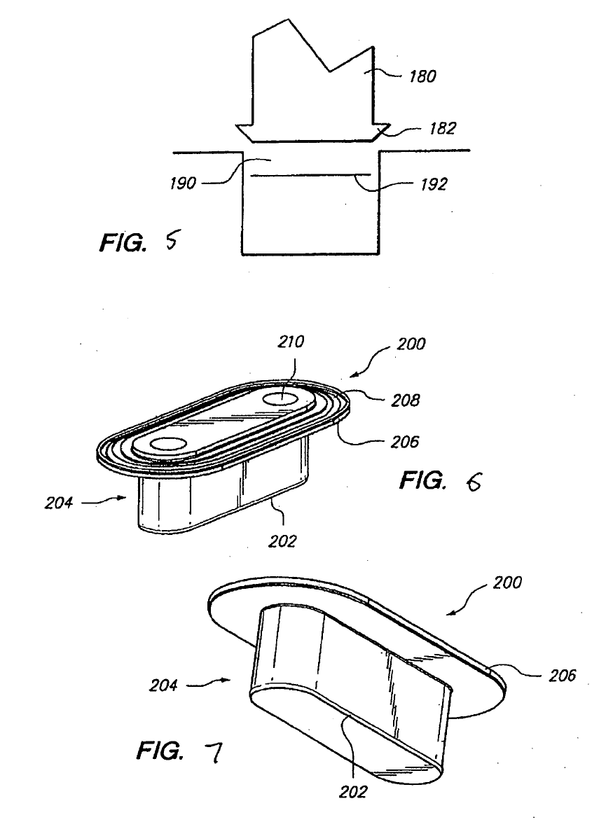

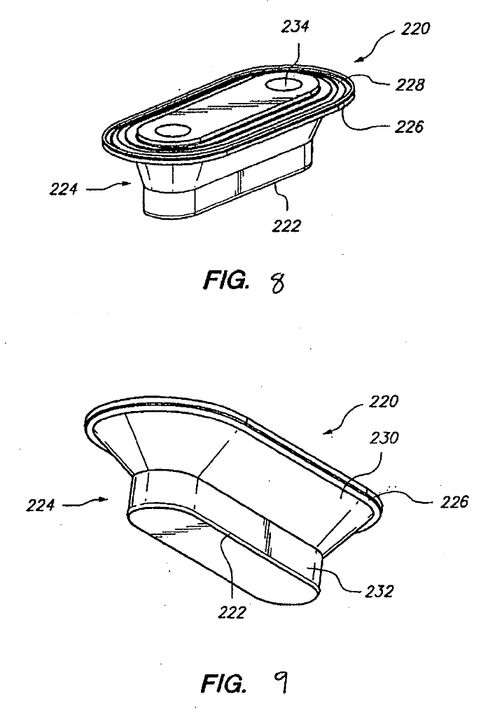

FIG. 3 is a diagram illustrating a top perspective view of a second version of a fin box in accordance with one embodiment of the invention. FIG. 4 is a diagram illustrating a bottom perspective view of the second version of the fin box of FIG. 3. FIG. 5 is a diagram illustrating a cross sectional view of a wedge shaped lip or barb being inserted into a fin cavity of a surfboard watercraft in accordance with one embodiment of the invention.

Referring now to FIGS. 3, 4, and 5, a second version of the fin box 170 includes an elongated box configuration with rounded distal ends. An upper portion 172 of the fin box 170 may have a radially extending flange 174. The radially extending flange 174 includes a plurality of through holes 176 or apertures formed therethrough about the entire periphery of the flange 174. A bottom portion 178 of the fin box 170 may have a reduced size base 180 with a barb or a wedge shaped lip 182 at a bottom end of the fin box 170, as depicted in FIG. 5. It is also contemplated that the reduced sized base may have two or more (e.g., four, etc.) barbs or wedge shaped lips 182. In one embodiment, the wedge shaped lip 182 may protrude out laterally about 0.060 inches from the reduced sized base 180. The wedge shaped lip 182 is angled such that the wedge 182 permits the bottom portion 178 to be inserted into the fin cavity 190 machined into the bottom surface of the watercraft, but does not permit the withdrawal of the fin box 170 therefrom. In some embodiments, an adhesive or quick setting epoxy 192 may be applied between the fin box 170 and the fin cavity 190.

The fin cavity 190 formed in the watercraft may be sized slightly smaller than the outer periphery of the wedge lip 182 but slightly larger than the outer periphery of the reduced size base 180, as shown in FIG. 5. In some embodiments, the upper portion 172 of the fin box 170 may have a protrusion 186 that is about 0.0050″ above a top surface 188 of the radially extending flange 174. In this manner, the coating covers the flange 174 and may be flush with the protrusion. The fin box 170 may have two circular fin apertures 184 disposed through the protrusion 186. In some embodiments, these fin apertures 184 may be spaced about 1.5″ from each other to receive corresponding posts of the fin.

FIG. 6 is a diagram illustrating a top perspective view of a third version of a fin box in accordance with one embodiment of the invention. FIG. 7 is a diagram illustrating a bottom perspective view of the third version of the fin box of FIG. 6. Referring now to FIGS. 6 and 7, a third version of the fin box 200 may have a similar configuration as the second version of the fin box 170. For example, the third version of the fin box 200 may have a wedge shaped lip 202 at a bottom outer periphery of the lower portion 204. The third version of the fin box 200 may have a different configuration from the second version of the fin box 170 in that the radially extending flange 206 does not have a plurality of through holes; rather, the radially extending flange 206 has at least one annular groove 208 on its top surface.

FIG. 8 is a diagram illustrating a top perspective view of a fourth version of a fin box in accordance with one embodiment of the invention. FIG. 9 is a diagram illustrating a bottom perspective view of the fourth version of the fin box of FIG. 8. Referring now to FIGS. 8 and 9, a fourth version of the fin box 220 may have a similar configuration as the third version of the fin box 200. For example, the fourth version of the fin box 220 may have a wedge shaped lip 222 at a bottom outer periphery of the lower portion 224. In addition, a top surface of the radially extending flange 226 may have at least one annular groove 228. However, unlike the third version of the fin box 200, a frusto-conical surface 230 may join the radially extending flange 226 and the base 232.

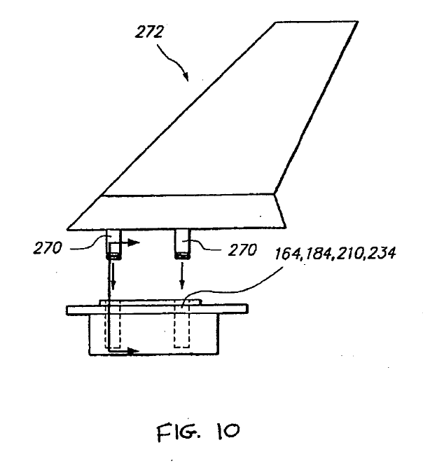

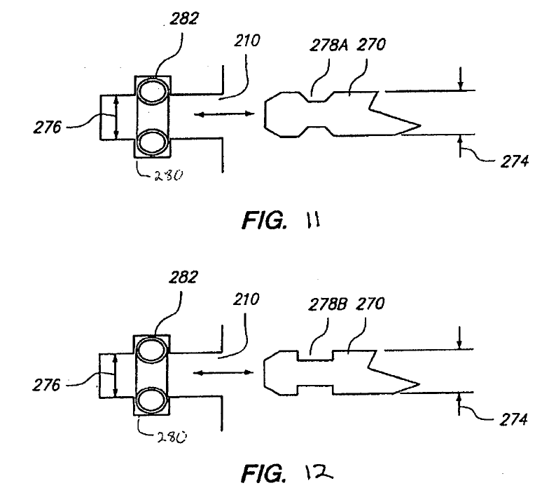

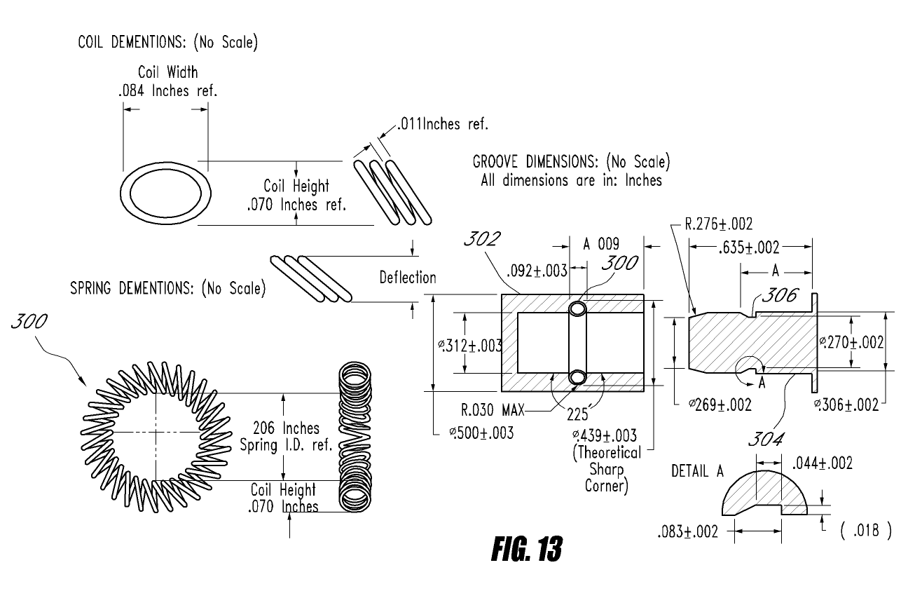

Referring now to FIG. 10, in one embodiment, the posts 270 of the watercraft fin 272 may be attached to the fin apertures 210 of the fin box 200. FIG. 10 illustrates the third version of the fin box 200 but it is contemplated that the manner in which the posts 270 are attached to the fin apertures 210 may be employed in the other versions of the fin box 150, 170, and 220.

FIG. 11 is a diagram illustrating a cross sectional view of the post and fin aperture of FIG. 10 illustrating a first version of the attachment between the post and fin aperture. FIG. 12 is a diagram illustrating a second version of the attachment between the post and fin aperture in accordance with one embodiment of the invention. Referring now to FIGS. 11 and 12, which illustrate two versions for attaching the posts 270 of the watercraft fin 272 to the fin aperture 210 of the fin box 200, the post 270, may be sized and configured to slide within fin aperture 210 of the fin box 200.

As illustrated in FIGS. 11 and 12, in one embodiment, the outer diameter 274 of the post 270 is smaller than an inner diameter 276 of the fin aperture 210. The post 270 is also formed with a first undercut groove 278A and 278B, which circumscribes the post 270. In one embodiment, the fin aperture 210 may be formed with a second undercut groove 280, which may be aligned to the first undercut groove 278A and 278B.

In some embodiments, the undercut grooves 278A, 278B, and 280 may be cut such that the groove is less than half of the thickness of a coil in the canted-coil spring 282. In some embodiments, the undercut grooves 278A, 278B, and 280 may be cut so that the total thickness of the grooves 278A and 280 or 278B and 280 are approximately the same as the thickness of a coil in the canted-coil spring 282. In some embodiments, the dimensions vary from implementation to implementation; however, these dimensions are selected so that the canted-coil spring provides enough pressure to hold, for example, a fin device to a watercraft, such as a surfboard.

A canted-coil spring 282 may be inserted into the second undercut groove 280. In some embodiments, a canted coil spring may be a round-wire spring with inclining (canted), elliptical coils that deflect independently when compressed. The entire spring 282 responds whenever any portion of the coil is deflected, permitting uniform loading at each contact point. By way of example and not limitation, a canted-coil spring 282 sold under the trademark BALSEAL™ Engineering of Foothill Ranch, Calif. may be inserted into the second undercut groove 280.

In FIG. 11, the post 270 may be inserted into the fin aperture 210 and removed therefrom by pushing and pulling the post 270 into and out of the fin aperture 210. The post 270 illustrated in FIG. 12 may also be inserted and removed from the fin aperture but requires a greater push in force and pull out force compared to the structure shown in FIG. 11. The reason is that the first undercut groove 278A shown in FIG. 11 is beveled, whereas the first undercut groove 278B shown in FIG. 12 is squared off. In use, the post 270 may be inserted into the fin aperture 210. Upon insertion, the outer diameter 274 of the post 270 pushes the canted-coil spring 282 outward until the canted coil spring 282 is seated in the first undercut groove 278A, B. The bevel of the first undercut groove 278A shown in FIG. 11 permits a user to pull the post 270 out of fin aperture 210 with less force compared to the post 270 and fin aperture 210 shown in FIG. 12.

FIG. 13 is a diagram illustrating an example canted spring design in accordance with the invention. Referring now to FIG. 13, a canted-coil spring 300 is illustrated. As discussed above, in some embodiments, the canted-coil spring 300 may be a round-wire spring with inclining (canted), elliptical coils that deflect independently when compressed. The entire spring 300 responds whenever any portion of the coil is deflected, permitting uniform loading at each contact point.

In one embodiment, the canted spring 300 includes a housing 302. The canted-coil spring 300 may be selected to fit in a groove or channel in the housing 302. Additionally, the housing 302 may be configured to receive a shaft 304. In one embodiment, the post may be part of a fin. In another embodiment, the post may be configured to be attached to a fin. In some embodiments, the shaft 304 can include a groove 306. When the shaft 304 is inserted in the fin box 302, canted-coil spring 300 can hold the shaft 304 in place by contacting the groove 306. The example illustrated in FIG. 13 is similar to the examples illustrated in FIGS. 11 and 12, and includes various measurements and tolerances. It will be understood that the embodiment depicted in FIG. 13 is exemplary and for illustrative purposes only, and that other canted spring sizes and shapes can be used with different housing sizes and shapes or different shaft sizes and shapes, without departing from the scope of the embodiments disclosed herein.

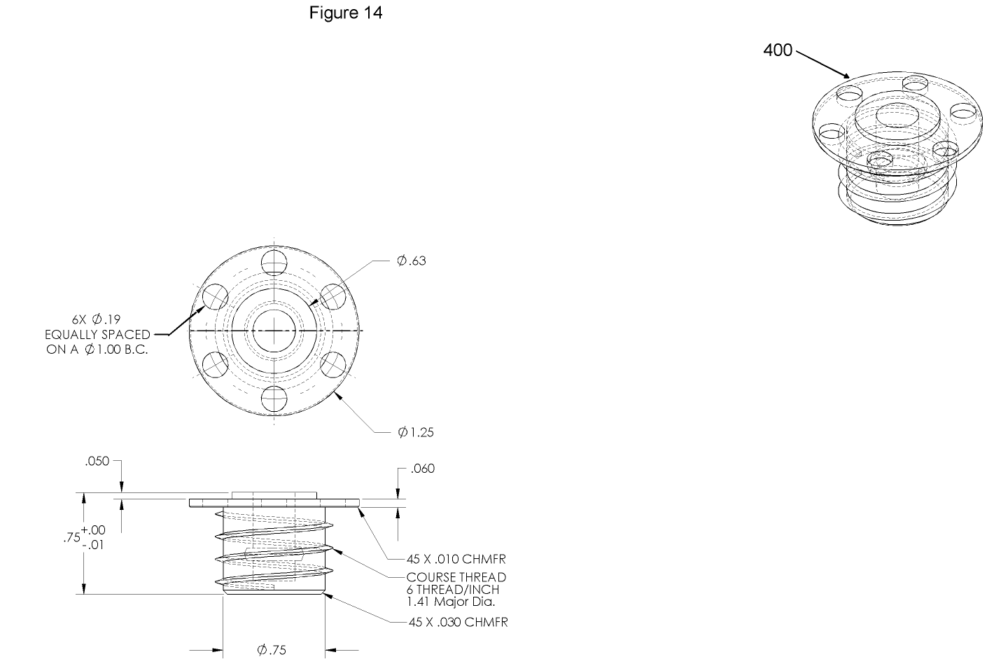

FIG. 14 is a diagram illustrating an exemplary fin box design in accordance with the invention. Referring now to FIG. 14, fin box 400 is illustrated. Fin box 400 includes thread 402, which may comprise a course thread used to secure a fin receptor into a watercraft. The coarse thread can also be referred to as a “wide auger” thread. While the example illustrated in FIG. 14 includes specific dimensions, it will be understood that many other sizes and shapes of fin plugs can be used in conjunction with the invention.

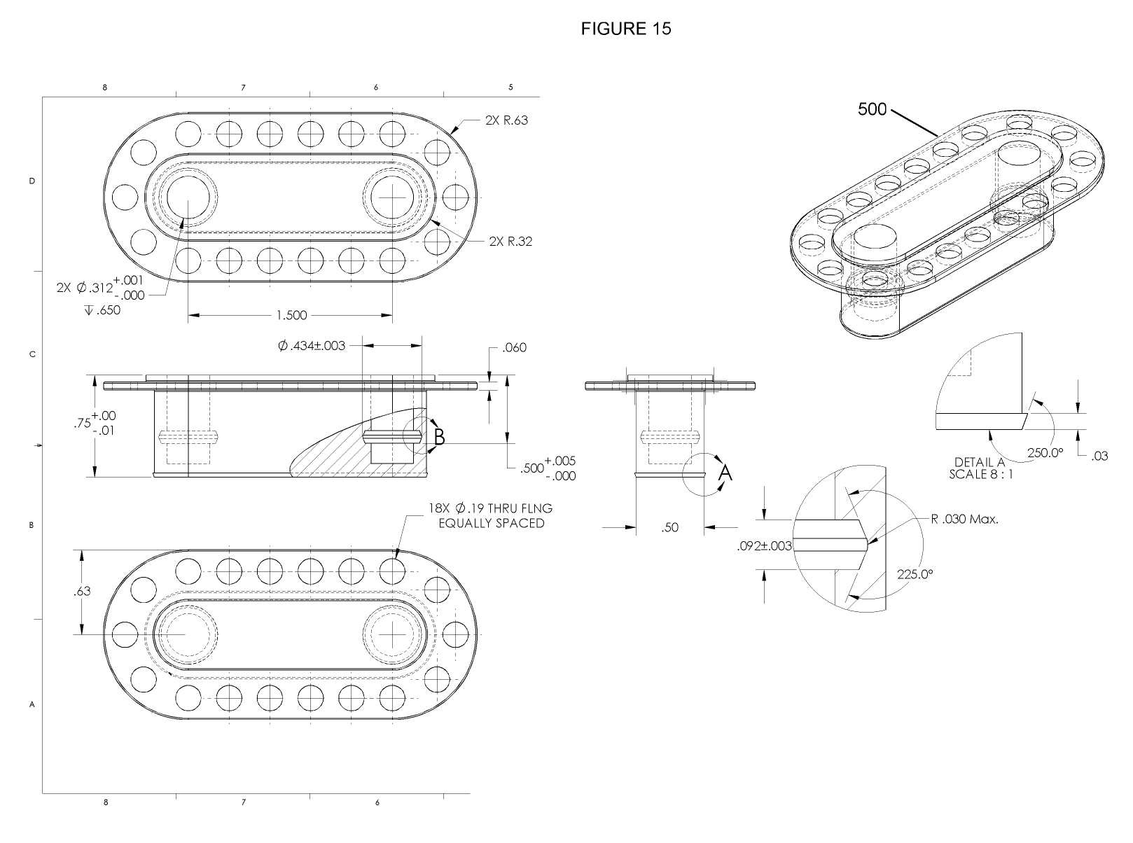

FIG. 15 is a diagram illustrating another exemplary fin box design in accordance with the invention. Referring now to FIG. 15, non-circular fin box 500 is illustrated. By using a fin plug that is not circular, e.g., fin box 500, it may be less likely that the fin box 500 will rotate. Accordingly, a fin attached to the fin box 500 will be less likely to rotated and the fin may retain some, e.g., predetermined alignment with the watercraft to which it is attached. While the example illustrated in FIG. 15 includes specific dimensions, it will be understood that many other sizes and shapes of fin plugs can be used in conjunction with the systems and methods described herein.

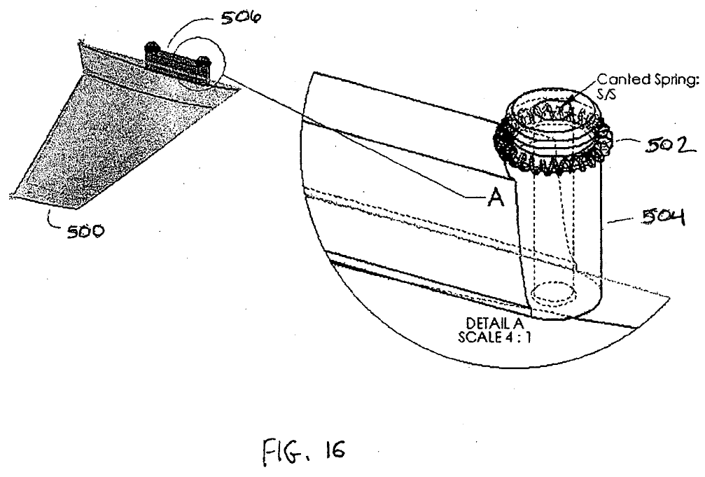

FIG. 16 is a diagram illustrating an exemplary canted spring latch that illustrates possible surf pin locations on a fin in accordance with the systems and methods described herein. Referring now to FIG. 16, a fin 500 is attached to a watercraft using a canted-coil spring 502 attached to a post 504. The canted-coil spring 502 and post 504 are dimensioned to slide into a receiving portion of a watercraft and thereby be secured in place.

The example embodiment of FIG. 16 is similar to the example embodiment of FIG. 10. As illustrated in FIGS. 10, 11, and 12, canted-coil spring 282 can be positioned inside of a fin aperture 210. In this way, the canted-coil spring 282 can engage the post 270 when it is inserted into the fin aperture 210.

Returning to FIG. 16, in some embodiments, the canted-coil spring 502 can be attached to the post 504. In other words, the position of the canted-coil springs 282 and 502 are swapped between the two embodiments. As illustrated in FIGS. 10, 11, 12, and 16, a pair of posts 270 or 504 and canted-coil springs 282 or 502 can be used. In this way, the fin 272, 500 is less likely to rotate within its attachment mechanism when positioned on a watercraft. As illustrated in FIG. 16, in some embodiments, a bar 506 can be used to make the fin 500 less likely to rotate.

In another embodiment, the post(s) can be attached to a watercraft, while the receptacle that receives the posts can be part of or attached to the device to be attached to the watercraft. For example, in one embodiment, a watercraft can include a pair of posts inserted into receptacles in a fin securing the fin to the watercraft using the canted-coil springs. It will be understood that the receptacles in the fin can, in some embodiments, be part of the fin, while in other embodiments, the receptacles can be a separate assembly attached to the fin.

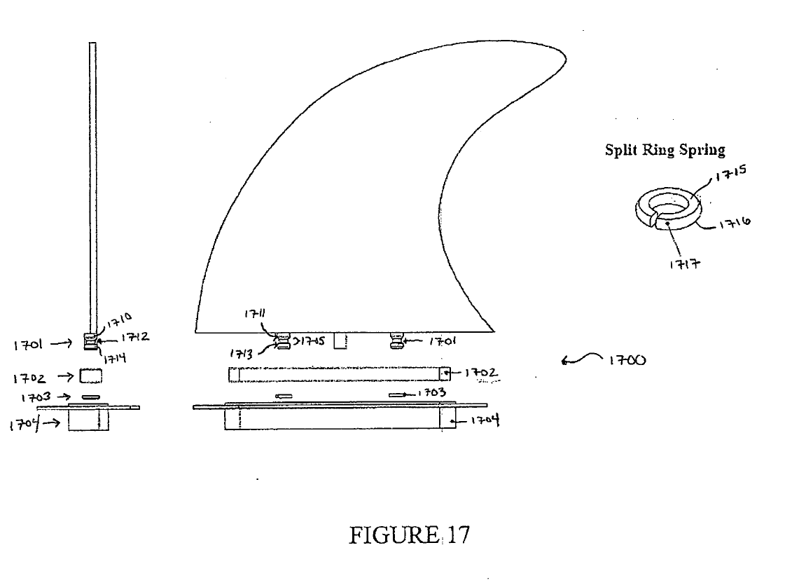

FIGS. 17-19 illustrate various embodiments wherein the attachment methods and devices are used for attaching a fin device to a surf board object. Referring to FIG. 17, one embodiment of a split ring assembly 1700 may include an post 1701 having a annular groove 1705 configured to pass through a housing lid 1702 and receive a spring, such as split ring spring 1703 and rest in a housing 1704 having a inner cavity to receive the post 1701. In accordance with the embodiment shown in FIG. 17, the post 1701 is comprised of a plurality of components such as, for example, a top portion 1710, a top angle 1711, a middle groove 1712, a bottom angle 1713, and a bottom portion 1714. The annular groove 1705 made up of the top angle 1711, middle groove 1712 and bottom angle 1713. The top portion 1710 having means to attach to a surface of an object by screw, adhesive or other means. The top angle 1711 specifically designed to be complimentary with the top inner angle of the split ring 1703. A change in angle conditions effects the insertion and desertion forces of the locking mechanism. The wider the diameter and the thicker the split ring 1703, the stronger the hold achieved by the locking mechanism. The groove middle 1712 is configured to make contact with the split ring once locking has been achieved. The bottom angle 1713 specifically designed to be complimentary with the inside bottom inner angle of the split ring 1703. The bottom portion 1714 designed to hold the split ring 1703 in place to provide a means for locking. The housing lid 1702 may be designed to permit the post 1701 to pass and receive a split ring 1703. In one embodiment, a housing lid 1702 may rest on top, at mid point, or at the bottom of a split ring 1703 to permit the post 1701 to receive the split ring 1703. The housing lid 1702 may be modified to allow for non-rotation between two objects being secured by the use of the post 1701. The split ring 1703 is circular in shape and has a portion cut off, to permit for expansion when the post 1701 receives and makes contact with the split ring 1703. The split ring 1703 may have a flat top surface 1715 and flat bottom surface 1716. Also, the split ring 1703 may have a flat or convex outer surface 1717. The split ring 1703 may have a flat inner surface (not shown), an angled inner surface (not shown) that permits the most surface area contact with the annular groove 1705. The housing 1704 is configured to receive at least the post 1701 and the split ring 1703. The housing 1704 may be prefabricated to receive the elements mentioned above. Also, the housing 1704 may be designed to rest in flush configuration, a-top, or below the housing for the housing. FIG. 17 illustrates a fin having two posts 1701, one housing lid 1702 prefabricated for two posts 1701, two split rings 1703, a single housing 1704 having a shaped cavity resting in a flush configuration with the surfboard that receives two posts 1701 to provide a vertical locking mechanism that permits for the fins to be snapped-on or snapped-off with relative ease. The disclosed embodiment does not require the use of screws in order to secure the fin to the surfboard, but rather the use of the post 1701 and the split ring 1703 to provide a vertical locking mechanism. The vertical locking mechanism provides a lighter surfboard and the ability to quickly modify a surfboard fin configuration by permitting for snap-on and snap-off fins without requiring any external tools for assembly.

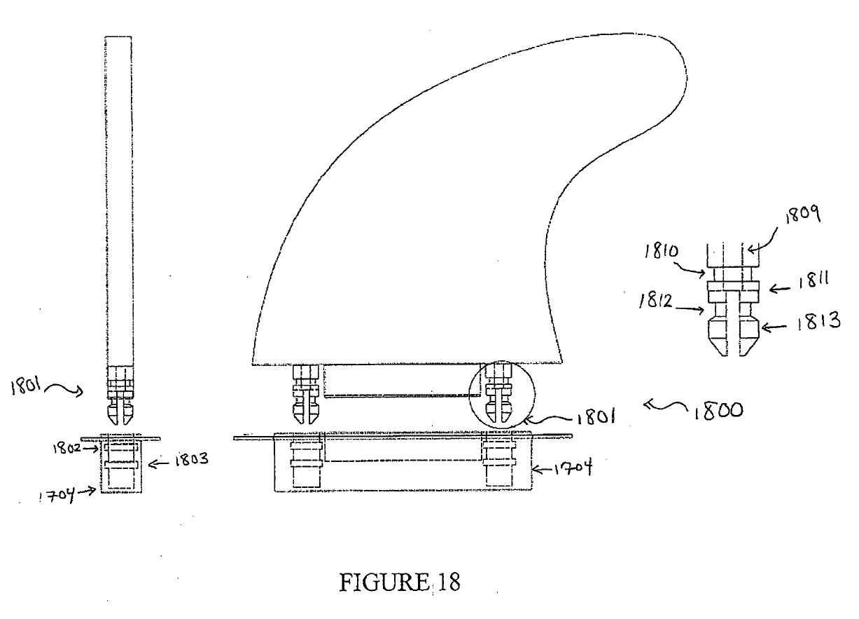

FIG. 18 illustrates a side view of a fin having a split post assembly. In one embodiment of a split post assembly 1800 may include a split post 1801 having a plurality of mouths 1813 configured to reside in the cavity of the housing 1704 having a contoured shape to receive the split post 1801. In accordance with the embodiment shown in FIG. 18, the split post 1801 is comprised of a plurality of components such as, for example, a top portion 1809, a first groove 1810, a thick portion 1811, a second groove 1812, and a plurality of mouths 1813. The top portion 1809 having means to attach to a surface of an object by screw, adhesive or other means. The first groove 1810 designed to have surface area contact with the first housing lid 1802 and support a vertical locking mechanism. The first groove 1810 may comprise complimentary angles to fit the cavity of the housing 1704. The thick portion 1811 is designed to rest between the first housing lid 1802 and the second housing lid 1803 and support a vertical locking mechanism. The thick portion 1811 may comprise complimentary angles to fit the cavity of the housing 1704. The second groove 1812 is designed to have the most surface area contact the cavity of the housing 1704 and support a vertical locking mechanism. the second groove 1812 may comprise complimentary angles to fit the civility of the housing 1704. The plurality of mouths 1813 are designed to pass through and rest in between the cavity of the housing 1704. The plurality of mouths 1813 may be flexed inward for insertion and may automatically expand outward and rest into place during insertion into the housing 1704 to provide a secure vertical locking mechanism. In one embodiment, the split post 1801 may have two mouths 1813, wherein the circular lower portion of the split post 1801 is divided or split in half to allow two flexible mouths 1813. In another embodiment, the split post 1801 may have four mouths 1813, wherein the circular lower portion of the split post 18001 is divided or split to four quadrants to allow for four flexible mouths 1813. The first housing lid 1802 and the second housing lid 1803 are part of the cavity of the housing and are designed to have a complimentary shape to the first groove 1810 and the second groove 1812 of the post 1801. The first housing lid 1802 makes contact with the first groove 1810 of the split post 1801. The second housing lid 1803 makes contact with the second groove 1812 of the split post 1801 as shown in FIG. 18 having small partitions to permit the plurality of mouths 1813 to flex. The housing 1704 is configured to receive, at least in part, the split post 1801. The housing 1704 may be prefabricated to receive the elements mentioned above in the description of FIG. 1S. Also, the housing 1704 may be designed to rest in flush configuration, a-top, or below the housing for the housing. FIG. 18 illustrates a fin having two split posts 1801 and a single housing 1704 resting in a flush configuration with the surfboard that receives two split posts 1801 to provide a vertical locking mechanism that permits for the fins to be snapped-on or snapped-off with relative ease. The split post 1801 may be snapped-off by compressing the plurality of mouths 1813 inward to decrease the contact with the surface area of the housing 1704 to permit for release. The split post 1801 may be snapped-on by compressing the plurality of mouths 1813 inward to permit insertion into the contoured cavity of the housing 1704, whereby the plurality of mouths 1813 automatically flex outward, make contact with the cavity of the housing 1704 and lock securely into place.

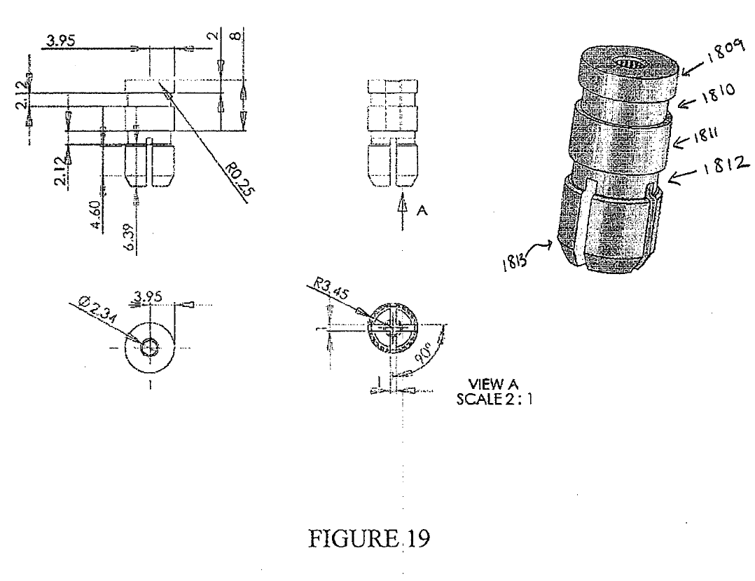

FIG. 19 is a detailed view of a split post assembly. FIG. 19 provides a detailed view of some the elements described in FIG. 18. As previously described, the split post 1801 comprises a top portion 1809 that attaches to an object, a first groove 1810 that is fitted for the first housing lid 1802 (not shown), a thick portion 1811 that provides locking support, a second groove 1812 that is fitted for the second housing lid 1803 (not shown), and a plurality of mouths 1813 configured to flex inward for insertions and desertion and outward during locking, as shown in FIG. 19.

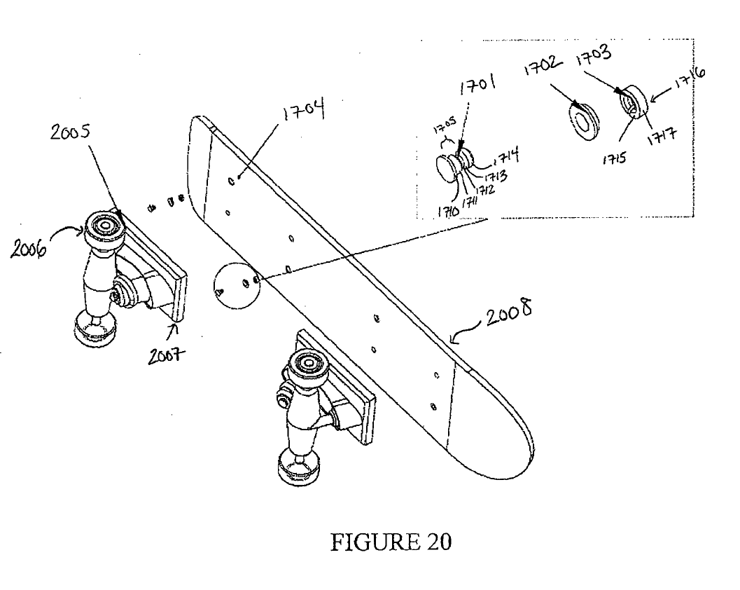

FIG. 20 illustrates a skateboard locking assembly. One embodiment of the skateboard locking assembly 2000 may include a skateboard lower portion 2005, a post 1701, a housing lid 1702, a split ring 1703, and housing 1704. The skateboard lower portion 2005 may comprise at least one wheel 2006 and one base 2007 to be attached to the skateboard surface portion 2008 by a vertical locking mechanism. The base 2007 may be attached to the post 1701 by adhesive, screw or other means. In accordance with the embodiment shown in FIG. 20, the post 1701 is comprised of a plurality of components such as, for example, a top portion 1710, a top angle 1711, a middle groove 1712, a bottom angle 1713, and a bottom portion 1714. The annular groove 1705 may be made up of the top angle 1711, middle groove 1712 and bottom angle 1713. The top portion 1710 having means to attach to the base 2007 by screw, adhesive or other means. The top angle 1711 specifically designed to be complimentary with the inside top angle of the split ring 1703. The groove middle 1712 configured to make contact and receive the split ring. The bottom angle 1713 specifically designed to be complimentary with the inside bottom angle of the split ring 1703. The bottom portion 1714 designed to hold the split ring 1703 in place to provide a means for locking. The housing lid 1702 may be designed to permit the post 1701 to pass and receive a split ring 1703. In one embodiment, a housing lid 1702 may be rest on top, at mid point, or at the bottom of a split ring 1703 to permit the post 1701 to receive the split ring 1703. The split ring 1703 is circular in shape and has a portion cut off, to permit for expansion when the post 1701 makes contact the split ring 1703. The split ring 1703 may have a flat top surface 1715 and flat bottom surface 1716. Also, the split ring 1703 may have a flat or convex outer surface 1717. The split ring 1703 may have a flat inner surface or an angled inner surface that permits the most surface area contact with the specific angular dimensions of the annular groove 1705. A hole on the skateboard surface portion 2008, or the housing 1704, is configured to receive at least the post 1701, the housing lid 1702 and the split ring 1703. FIG. 20 illustrates a skateboard having two skateboard lower portions 2005, each skateboard lower portion 2005 configured for four posts 1701, four housing lids 1702, four split rings 1703, and four housings 1704 or holes to receive four posts 1701 to provide a vertical locking mechanism that permits for the skateboard lower portion 2005 to be snapped-on or snapped-off with relative ease. An attached skateboard base 2007 may be detached from a skateboard surface portion 2008 by applying a vertical force that decouples the post 1701 from the housing lid 1702 and the split ring 1703. Also, a detached skateboard base 2007 may be attached to a skateboard surface portion 2008 using a vertical force to couple the base 2007 having a post 1701 to the housing lid 1702 and the split ring 1703 to make surface area contact within the housing 1704 having a prefabricated cavity.

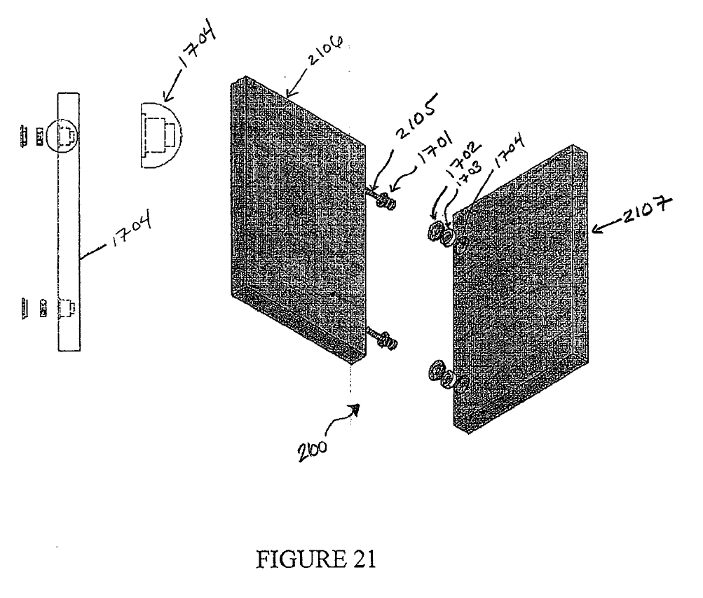

FIG. 21 illustrates a furniture locking assembly. One embodiment of the furniture locking assembly may include a wood base A 2106, a screw 2105, an post 1701, a housing lid 1702, a split ring 1703, a housing 1704, and a wood board B 2107. The wood base A 2106 may be configured to receive at least one post 1701 by means of a screw 2105 or other attachment means. The screw 2105 may be made of metal, plastic, wood, or any comparable material to permit for attachment of board A 2106 and board B 2107. The post 1701 is attached to the wood board A 2106 by means of a screw 2105 or any other alternative attachment means such as adhesive or welding, for example. The post 1701 configured to pass through a housing lid 1702 and be coupled to the inside surface area of the split ring 1703 and make contact with the indentations within wood board B 2107, or the housing 1704. The housing lid 1702 has a flat top and bottom portion and designed to allow the post 1701 to pass through to interface with the split ring 1703. The housing lid may rest a-top, at mid point, or below the split ring 1703. The split ring 1703 having a circular configuration and a cut-out portion to permit the split ring to expand in during insertion of the post 1701 and contract during removal of the post 1701. Also, the split ring 1703 having an angled inside portion and convex or flat outer portion. Also, the split ring 1703 having a flat top and bottom portion. The housing 1704 configured to receive at least the post 1701, the housing lid 1702, and the split ring 1703. Also, the housing 1704 may be designed to rest in flush configuration, a-top, or below the housing for the housing. FIG. 21 illustrates a furniture locking assembly comprising at a wood board A 2106, at least two posts 1701, two housing lids 1702, two split rings 1703 and a housing 1704 having two imbedded portions inside of wood board B 2107 to provide a vertical locking mechanism that permits for wood board A 2106 to be snapped-on or snapped-off with relative ease to wood board B 2107.

### Cleat Attachment Means

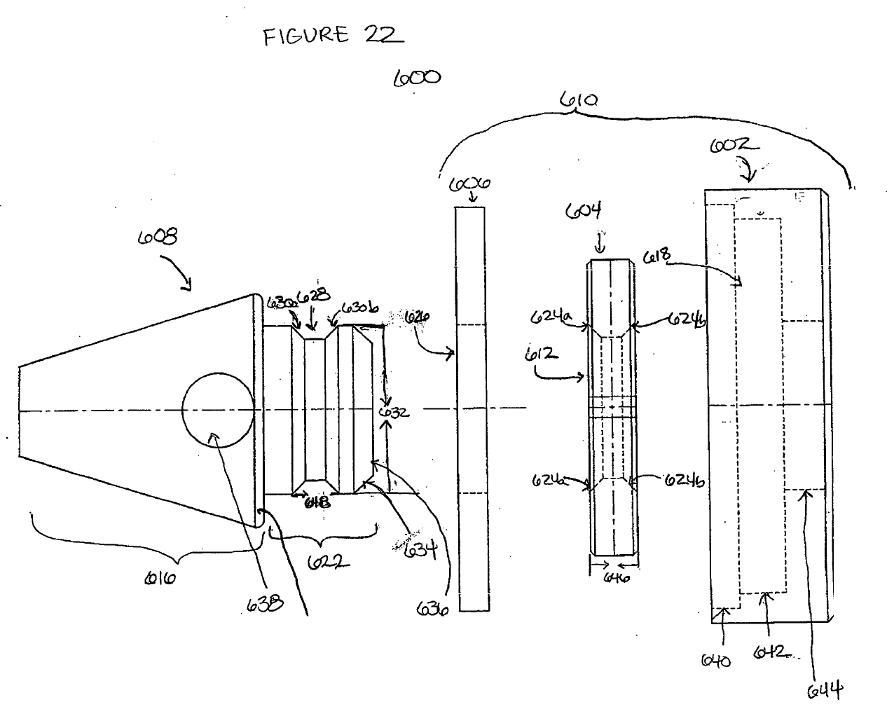

FIGS. 22-26 illustrate various embodiments wherein the attachment methods and devices are used for attaching a cleat device to a shoe object. Referring to FIG. 22, one embodiment of a cleat assembly 600 can include a housing 602 with an interior cavity 618 configured to receive a spring, such as a split ring spring 604. In accordance with the embodiment shown in FIG. 22, the interior cavity 618 of the housing 602 can be configured such that a split ring spring 604 sits fully within the interior cavity 618, with the cavity and the hole of the split ring spring 604 being coaxially aligned. In some embodiments, the interior cavity 618 of the housing 602 is configured such that a housing lid 606 with an aperture 620 also sits within the interior cavity 618 of the housing 602. The interior cavity 618, the aperture of the split ring 604 and the aperture of the housing lid 606 can be coaxially aligned. In the embodiment depicted in FIG. 22, the housing 602, the split ring spring 604, and the housing lid 606 together form the device receptacle 610. The diameter of the interior cavity 618 in which the split ring spring 604 sits is larger than the diameter of the split ring spring 604, in order to accommodate expansion of the split ring spring 604, for example when the device 608 is inserted into the device receptacle 610. The skilled artisan will appreciate that, although the components of the device receptacle 610 are depicted in FIG. 22 as being separate, that two or more of the components can, in some embodiments, be integral.

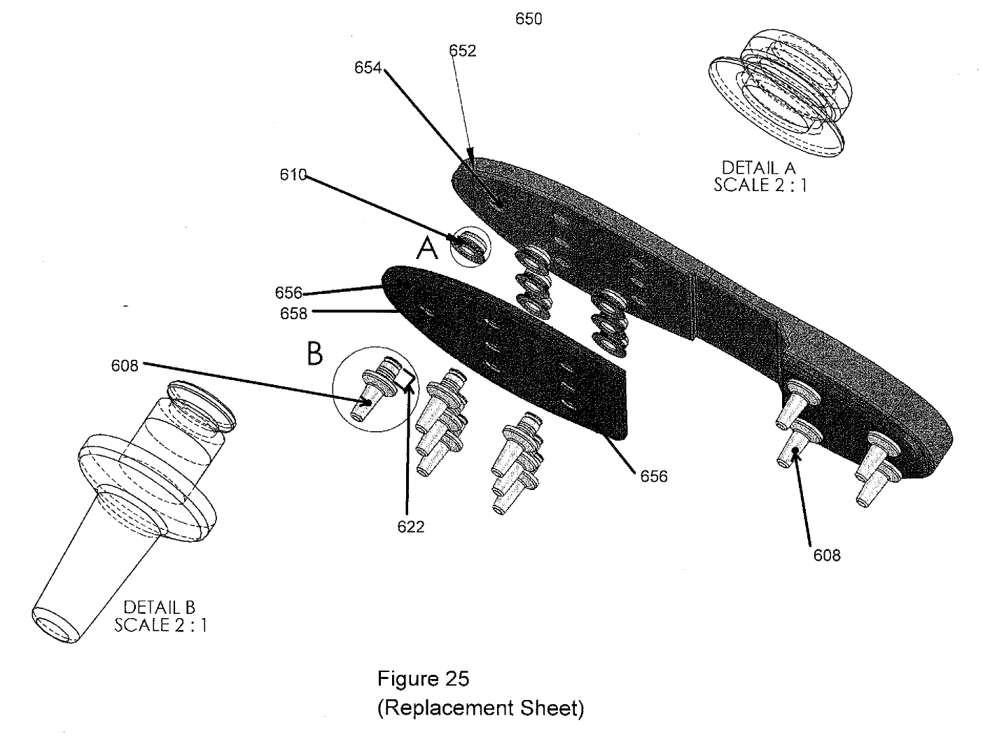

In some embodiments, the hosing lid and the housing are fixed or sealed together, for example, using glue, a threading mechanism (see, e.g. FIG. 25, discussed below), or any other means known by those skilled in the art appropriate for the intended purpose. The split ring spring 604 can sit within the interior cavity 618 of the sealed device receptacle 610.

As shown in FIG. 22, the top and bottom of the inside edge 624 of the split ring spring 604 that forms the center hole 612 can be beveled or angled at the top and/or bottom surface. For example, in some embodiments, the inside edge 624a, 624b of the hole 612 of the split ring spring 604 can be angled at a 15°, 20°, 25°, 30°, 40°, 45°, 50°, 55°, 60°, 65°, 70°, 75°, 80°, 85°, 90°, 95°, 100°, 120°, or greater angle. In preferred embodiments, the inside edge 624a, 624b of the hole 612 of the split ring spring 604 form a 90° angle. In some embodiments, the angles of the top 624a and bottom edges 624b of the hole 612 of the split ring spring 604 are different. Any split ring spring 604 can be used in the embodiments disclosed herein, for example from commercially available sources, or specifically manufactured for the attachment devices disclosed herein according to methods known to those skilled in the art.

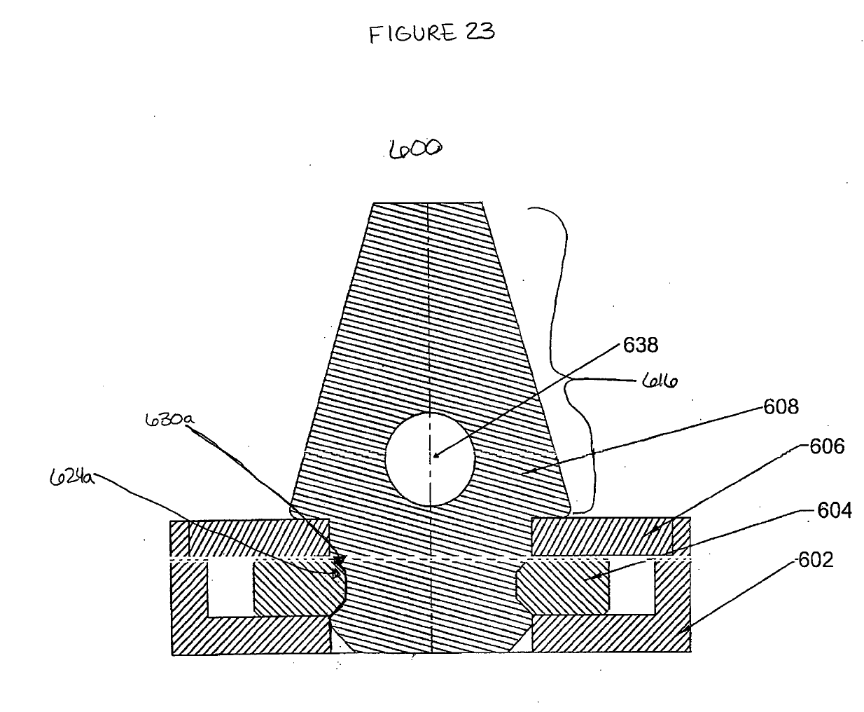

As shown in FIG. 22, the device 608, e.g., the cleat shown in FIG. 22, has a top portion 616 and a bottom portion comprising a post 622, which is inserted through the aperture 626 of the housing lid 606 of the device receptacle 610, through the hole 612 in the split ring spring 604, and into the interior cavity 618 of the housing 602. The post 622 can have an annular groove 628. Preferably, the groove 628 is defined by angular edges 630a, 630b, wherein the angle of the edges of the groove are complementary to the angles of the edges 624a, 624b that define the interior hole 612 of the split ring spring 604, such that when the post 622 is inserted into the interior cavity 618 of the device receptacle 610, the split ring spring 604 rests around the groove 628, as shown in FIG. 23. In some embodiments, the annular groove 628 is cut so that the total thickness of the groove 648 is approximately the same as the thickness 646 of the split ring spring 604.

As shown in FIG. 23, upon insertion, the outer diameter 632 of the post 622 pushes the split ring spring 604 outward until the split ring spring 604 is seated in the annular groove 628 of the post 622 when assembled. The restorative force of the split ring spring 604 around the groove 628 of the device 608 holds the device 608 in place within the device receptacle 610. As shown in FIGS. 22 and 23, in some embodiments, the distal end 634 of the post 622 can be beveled as well, in order to facilitate insertion and desertion of the cleat device 608 into the device receptacle. When assembled, the bottom face 660 of the post 622 of the cleat device 608 rests against the housing lid 606. In some embodiments, the housing lid 606 can have a detent that is complementary to the shape of the bottom face 660 of the post 622 of the cleat device 608. The bottom face 660 of the post 622 of the cleat device 608 can be any shape, such as circular, oval, square, rectangular, etc. Preferably, the shape of the bottom face 660 of the post 622 of the device 608 and the complementary detent in the housing lid 606 are asymmetrical, such that the cleat device 608 is less likely to rotate, and the cleat device may retain some, e.g., predetermined alignment with the shoe to which it is attached.

In some embodiments, the bottom portion of the device 608, e.g., the cleat, can include a hole 638 therethrough, to facilitate disassembly of the device 608 from the device receptacle 610.

The components of the device receptacle 610 can be made from any material, such as rigid polymers, ceramics, stainless steel, composites, polymer coated metal, and the like. In some embodiments, the components of the housing 602, the split ring spring 604 and the housing lid 606 are made from a rigid plastic material.

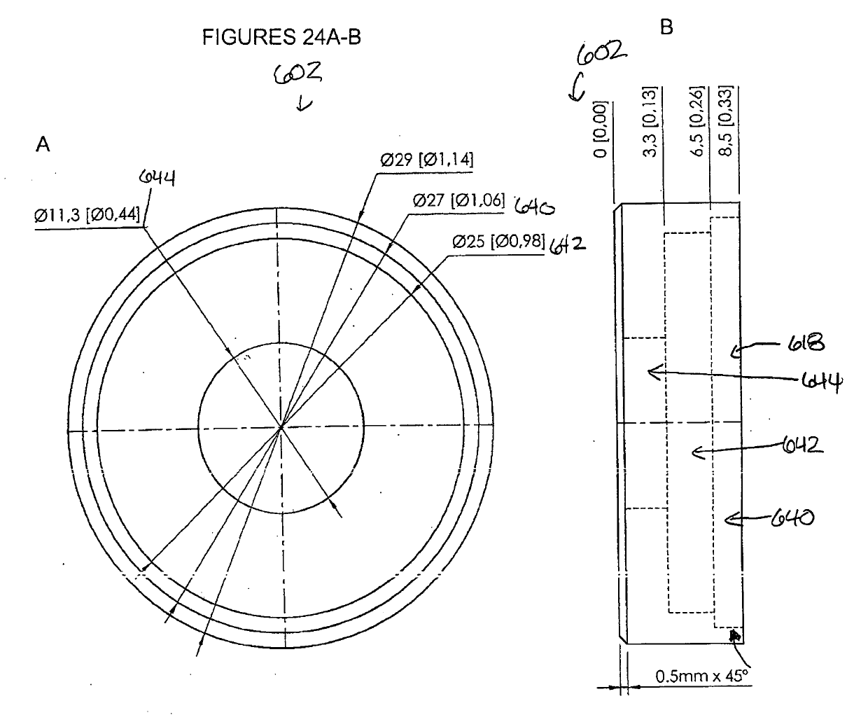

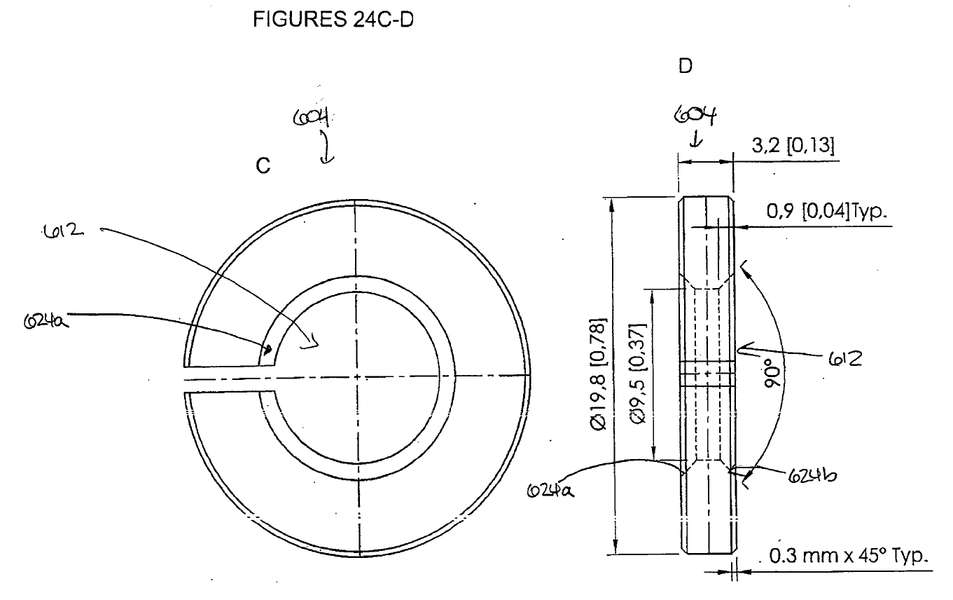

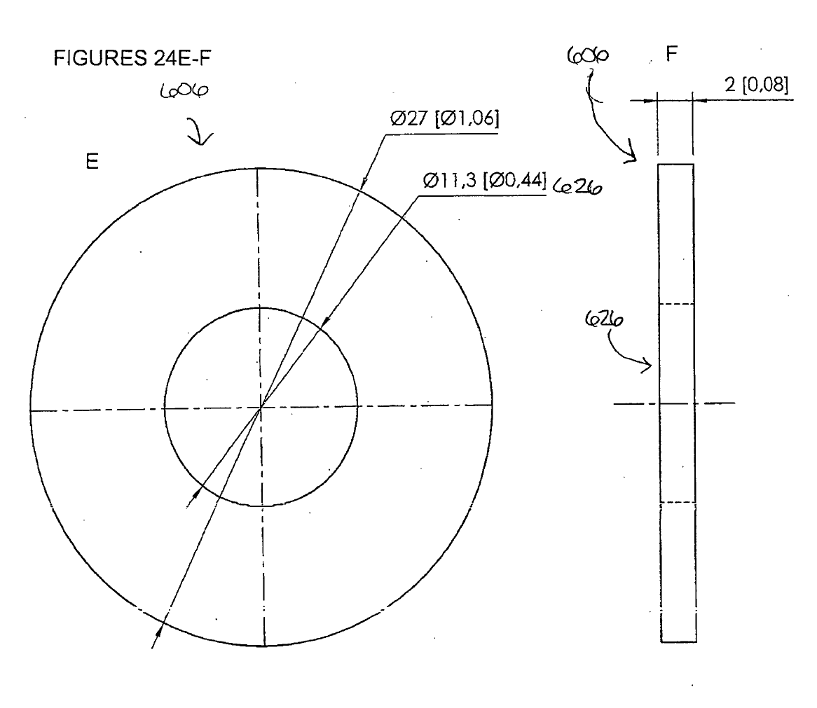

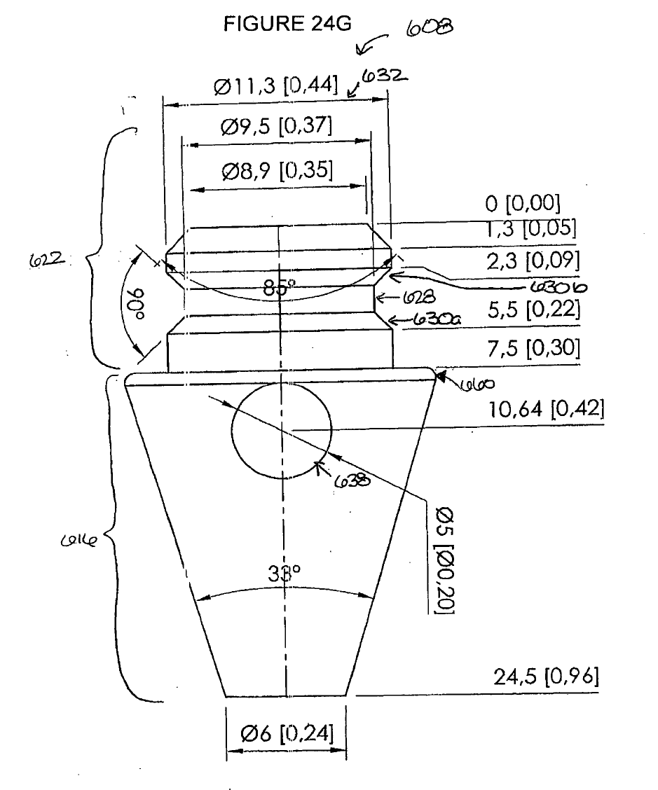

FIGS. 24A and 24B show a top view and a cross-sectional view, respectively, of an exemplary housing 602 used in the embodiments disclosed herein. The cross-sectional view illustrates the inner cavity 602 which can have three layers 640, 642, 646, each layer having a different-sized diameter. The three layers 640, 642, 646 of the inner cavity 618 are sized to fit the post 622 of the inserted device 608, the split ring spring (in expanded form) 604, and the housing lid, 606 respectively. FIGS. 24A and 24B include various measurements, however, it will be understood that many other sizes and shapes of housing bases can be used in conjunction with the attachment mechanisms disclosed herein.

FIGS. 24C and 24D show a top view and a cross-sectional view, respectively, of an exemplary housing lid 606 with an aperture 626 used in the embodiments disclosed herein. The diameter of the housing lid 606 is the same as the diameter of the top layer 640 of the inner cavity 618. In some embodiments, the thickness of the housing lid 606 is such that, when inserted into the housing 602, the top of the housing 602 and the housing lid 606 are flush. FIGS. 24C and 24D include various measurements, however, it will be understood that many other sizes and shapes of housing lids can be used in conjunction with the attachment mechanisms disclosed herein.

FIGS. 24E and 24F show a top view and a cross-sectional view, respectively, of a split ring spring 604. The diameter of the split ring spring 604 smaller than the diameter of the middle layer 642 of the inner cavity 618, but larger than the diameter the bottom layer 644 of the inner cavity 618. The diameter of the hole 612 in the center of the split ring spring 604 is the same size as the diameter of the groove 628 of the device post 622, and can expand to the diameter of the post 632, upon insertion of the post 622 into the device receptacle 610. As discussed above, the top 624a and bottom, 624b edges that define the hole 612 of the split ring spring 604 can be angled. The degree of the angle is complementary to the degree of the angles on the top 630a and bottom 630b edges of the groove 628 of the device post 622. FIGS. 24E and 24F include various measurements, however, it will be understood that many other sizes and shapes of split ring springs can be used in conjunction with the attachment mechanisms disclosed herein. For example, the thickness of the ring 606 (and the corresponding groove 628 on the post 622) can be varied, to provide for an increased or decreased locking force.

FIG. 24G shows a cross-sectional view of a cleat device 608. The bottom portion of the cleat device 616, which projects from the bottom of the sole of the shoe, can be any shape, such as, for example, the frusto-conical shape depicted in the cleat device shown in FIG. 24G. As discussed above, in some embodiments, the surface 660 of the bottom portion 622 of the cleat 608 that contacts the cleat receptacle 610 assembly when the device is assembled, can be designed in any shape, and can, in preferred embodiments, be complementary to a detent shape in the surface of the housing lid 606 that rests against the surface 660 when assembled. As shown in FIG. 24G, the top portion 622 of the cleat device 608 has an annular groove 628 which is defined by angled edges 630a, 630b. Preferably, the angle of the edges 630a, 630b of the annular groove 628 are complementary to the angles defining the hole 612 of the split ring spring 604, and the thickness and length of the annular groove 628 is such that the split ring spring 604 rests within the annular groove 628 when the cleat attachment device 600 is fully assembled. In some embodiments, the diameter of the bottom portion that is not defined by the annular groove (diameter of the outside edge of the post) 632 is the same as the diameter of the bottom layer 644 of the interior cavity 618 of the housing 602, such that the bottom-most portion of the bottom portion 634 of the cleat device rests within the third layer 644 of the cavity 618 housing 602. The diameter 632 of outside edge of the post 622 is greater than the diameter of the hole 612 of the split ring spring 604 when the split ring spring 604 is in its resting state, but is such that it can pass through the hole 612 of the split ring spring 604 during assembly, when the split ring spring 604 is expanded.

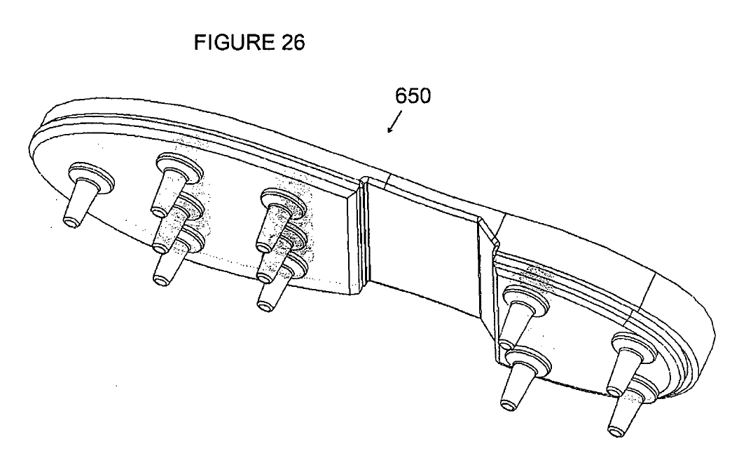

FIG. 25 shows an exploded perspective view of a cleat assembly matrix 650. In this embodiment, the sole of the shoe can comprise a first portion 652 and a second portion 656 that can be removably attached to the first portion 652. The first portion 652 of the sole is attached to the bottom of the shoe body, and can have a plurality of cleat cavities 654, wherein the cleat cavities are configured to receive a plurality of cleat receptacles 610. The cleat receptacles 610 are fixed in the cleat cavities 654 of the first portion of the sole, 652 for example, by glue, or other means. The second portion of the sole 656 can contain a plurality of apertures 658 that are positioned in the same arrangement as the cleat cavities 654 in the first portion 652 of the sole. A plurality of cleat devices 608 can be inserted through the apertures 658 of the second portion of the shoe sole, such that the posts 622 of the cleat devices 608 project through the second portion of the sole 656 and are exposed. In this matter, the posts 622 are exposed for insertion into the cleat receptacles 610. In the embodiment shown in FIG. 25, the plurality of posts 622 of the cleat devices 608 are received into the cleat receptacles 610 of the first portion of the sole 652, thereby attaching the second portion of the sole 656 with the cleat devices 608 to the first portion of the sole 652 and shoe. A perspective view of an assembled cleat assembly matrix 620 is depicted in FIG. 26.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. In addition, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described. These example embodiments may instead be applied, alone or in various combinations, to one or more of the other embodiments of the invention. This is true whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof, the terms “a” or “an” should be read as meaning “at least one,” “one or more,” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An attachment mechanism to secure a device to an object, comprising:
a device receptacle configured to fit within a cavity of the object, the device receptacle comprising a housing with an interior cavity, the interior cavity being configured to receive a device; and
a device comprising a top portion and an bottom portion, the bottom portion comprising a post configured to be inserted into the device receptacle, wherein the post comprises an annular groove; and
a locking means to retain the annular groove of the post in a fixed position within the device receptacle, wherein the locking means is either located on the post or within the interior cavity of the device receptacle, prior to insertion of the post into the device receptacle.

2. The attachment mechanism of claim 1, wherein the locking means comprises a split ring spring, and wherein the device receptacle comprises the split ring spring, the split ring spring having a hole having a diameter, wherein the diameter of the hole of the split ring spring is the same as the diameter of the annular groove of the post, and wherein the diameter of the hole of the split ring spring can expand to the size of the diameter of the outside edge of the post.

3. The attachment mechanism of claim 2, wherein the device receptacle further comprises a housing lid with an aperture, wherein the diameter of the aperture is the same as the diameter of the outside edge of the post.

4. The attachment mechanism of claim 3, wherein the split ring spring and the housing lid sit within the interior cavity of the housing, and wherein the housing lid and the housing base are attached.

5. The attachment mechanism of claim 4, wherein the housing lid and the housing base are releasably attached.

6. The attachment mechanism of claim 4, wherein the housing lid and the housing base are integral.

7. The attachment device of claim 2, wherein the edges defining the annular groove of the post are angled.

8. The attachment mechanism of claim 7, wherein the angle of the annular groove determines the strength of the locking means.

9. The attachment device of claim 8, wherein the edges defining the hole of the split ring are angled, and wherein the angles of the edges defining the annular groove of the post and the angles of the edges defining the hole of the split ring are complementary.

10. The attachment mechanism of claim 1, wherein the post comprises a split post, wherein the split post comprises mouths configured to enable compression of the split post to be received into the interior cavity of the housing receptacle.

11. The attachment mechanism of claim 1, wherein the device is a cleat and the object is a shoe.

12. The attachment mechanism of claim 1, wherein the device is a fin and the object is a watercraft.

13. The attachment mechanism of claim 1, wherein the device is a skateboard deck and the object is a skateboard wheel truck.

14. The attachment mechanism of claim 1, wherein the device is a first component of a piece of furniture, and the object is a second component of a piece of furniture.

15. A shoe, comprising
a sole comprising a first portion attached to the bottom of the shoe, the first portion of the sole comprising at least one cavity configured to receive a device receptacle;
a device receptacle comprising a housing, a split ring spring and a housing lid, wherein the split ring spring and the housing lid sit within an interior cavity of the housing; and
a cleat comprising a top portion and an bottom portion, wherein the top portion comprises a post, and wherein the post comprises an annular groove, the annular groove of the post having a second diameter that is smaller than the diameter of the outside edge of the post.

16. The shoe of claim 15, wherein the device receptacle comprises a split ring spring with a hole having a diameter, wherein the diameter of the hole of the split ring spring is the same as the diameter of the annular groove of the post, and wherein the diameter of the hole of the split ring spring can expand to the size of the diameter of the outside edge of the post.

17. The shoe of claim 15, wherein the device receptacle further comprises a housing lid with an aperture, wherein the diameter of the aperture is the same as the diameter of the outside edge of the post.

18. The shoe of claim 16, wherein the split ring spring and the housing lid sit within the interior cavity of the housing.

19. The shoe of claim 16, wherein the edges defining the annular groove of the post are angled.

20. The shoe of claim 16, wherein the edges defining the hole of the split ring are angled, and wherein the angles of the edges defining the annular groove of the post and the angles of the edges defining the hole of the split ring are complementary.
